(19) United States
(12) Patent Application Publication
(10) Pub. No.: US 2010/0065712 A1
(43) Pub. Date: Mar. 18, 2010

(54) DEVICE AND METHOD FOR SECURING AND SUSPENDING ITEMS

(76) Inventor: Duane David Vanwitzenberg, Hobart, IN (US)

Correspondence Address: HARTMAN & HARTMAN, P.C., 552 EAST 700 NORTH, VALPARAISO, IN, 46383, US

(21) Appl. No.: 12/561,303

(22) Filed: Sep. 17, 2009

Related U.S. Application Data
(60) Provisional application No. 61/098,010, filed on Sep. 18, 2008.

(51) Int. Cl. F16M 13/00

(52) U.S. Cl. 248/610

(57) ABSTRACT

A device and method for securing and suspending items. The device includes a rail and at least two walls extending in a transverse direction to the rail. Each wall terminates at a distal end spaced apart from the rail, and the rail and walls delineate a slot between the walls. A resilient member extends from one wall toward the other wall, and is operable to extend into the slot and be resiliently deflected between first and second positions within the slot. The resilient member is biased away from the rail so that in its first position a distal tip thereof is resiliently deflected toward the rail to define a gap with the second wall for receiving a portion of an item, and in the second position the distal tip is resiliently biased toward the second wall to define a pinch point therebetween for securing the item.

### CROSS REFERENCE TO RELATED APPLICATIONS

This application claims the benefit of U.S. Provisional Application No. 61/098,010, filed Sep. 18, 2008, the contents of which are incorporated herein by reference.

### BACKGROUND OF THE INVENTION

The present invention generally relates to devices and methods for securing items, and more particularly to a device configured for organizing, securing and suspending items, for example, suspending bagged food packages from a wall or door, beneath a shelf or cabinet, etc.

Various devices have been proposed that are capable of securing and suspending various objects or items, such as bagged products. For example, U.S. Pat. No. 6,279,204 to Gonzalez discloses a bag-retaining clip formed by two legs that are pivotably coupled at one end to enable the legs to be rotated toward each other and clamp onto an edge of a bagged product (potato chip bag). Other examples utilize resilient features for securing a bagged product, such as an article holder disclosed in U.S. Pat. No. 6,257,422 to Rios and a clip strip disclosed in U.S. Pat. No. 5,967,341 to Werner. Rios' holder comprises a gripping feature defined by a downward-facing opening into which the edge of a bagged product can be inserted and a member horizontally biased to close the opening. Werner's clip strip also comprises a gripping feature defined by a horizontally-biased member that acts to close a downward-facing opening into which the edge of a bagged product can be inserted and held by the member.

### BRIEF DESCRIPTION OF THE INVENTION

The present invention provides a device and method suitable for organizing, securing and suspending items.

According to a first aspect of the invention, the device includes a rail extending in a longitudinal direction and having a longitudinal side, and at least first and second walls extending from the longitudinal side of the rail in directions transverse to the longitudinal direction. Each of the first and second walls terminates at a distal end spaced apart from the rail, and with the rail the first and second walls delineate a slot between the first and second walls. A resilient member extends from the first wall and toward the second wall, and is operable to extend into the slot and be resiliently deflected between first and second positions within the slot. The resilient member is biased away from the rail so that in the first position of the resilient member a distal tip thereof is resiliently deflected toward the rail and defines a gap with the second wall for receiving a portion of an item, and in the second position of the resilient member the distal tip thereof is resiliently biased toward the second wall to define a pinch point therebetween for securing the item.

According to a second aspect of the invention, the method of securing and suspending an item includes pushing an edge of the item against a resilient member to cause the resilient member to resiliently deflect into a slot between first and second walls and enable the edge of the item to enter the slot through a gap between a distal end of the resilient member and the second wall, and then releasing the item. The resilient member is biased in a direction away from the slot so that the distal tip of the resilient member is resiliently biased toward the second wall to define a pinch point therebetween that secures the item.

A significant advantage of this invention is that the method of using the device is uncomplicated, and the device is capable of having an uncomplicated construction that is amenable to mass production processes. In addition, the device can be used to secure and suspend a wide variety of items, nonlimiting examples of which include jackets, hats, towels, swimming pool accessories like swim goggles, life jackets and floaties, household and gardening items such as extension cords and bagged lawn and garden supplies, and bagged food products. For example, the device is capable of securing, organizing and sealing bagged food products such as snack chips, dried soups, dried seasoning mixes, etc. The device can also be configured for mounting to a variety of surfaces and structures, including walls, doors, under cabinets and shelves, or any other convenient location.

Other aspects and advantages of this invention will be better appreciated from the following detailed description.

### BRIEF DESCRIPTION OF THE DRAWINGS

FIG. 1 is a side view of a device adapted for securing, suspending and organizing items in accordance with a first embodiment of the present invention.

FIG. 2 is a perspective view of the device of FIG. 1.

FIGS. 3 through 7 are side views of devices configured in accordance with additional embodiments of the present invention.

FIGS. 8 and 9 are perspective and side views, respectively, of a device configured in accordance with a preferred embodiment of the present invention.

### DETAILED DESCRIPTION OF THE INVENTION

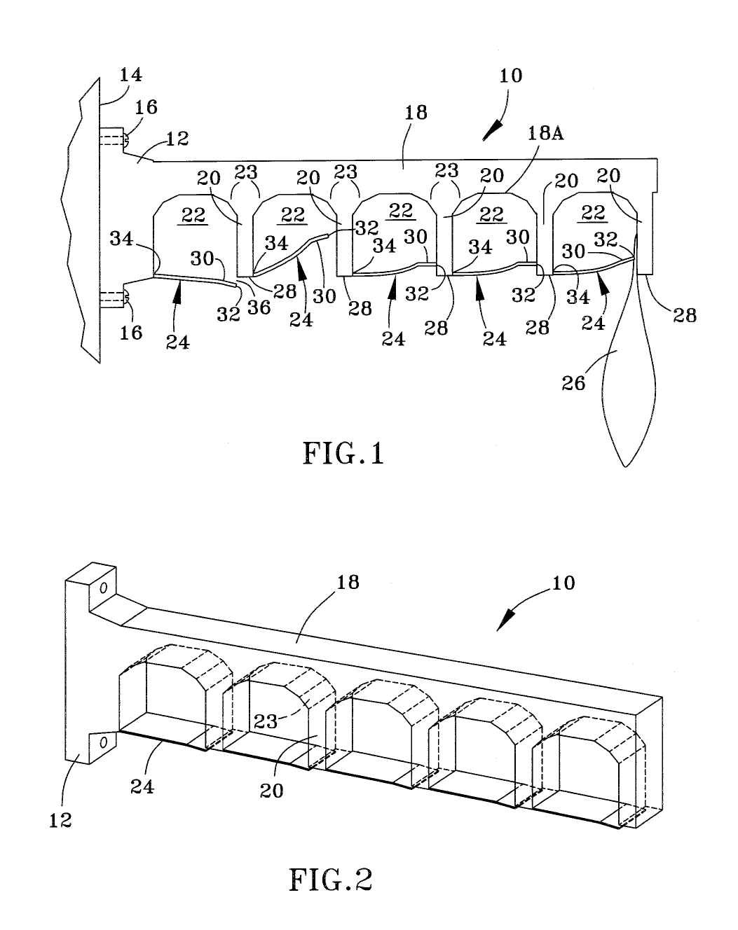

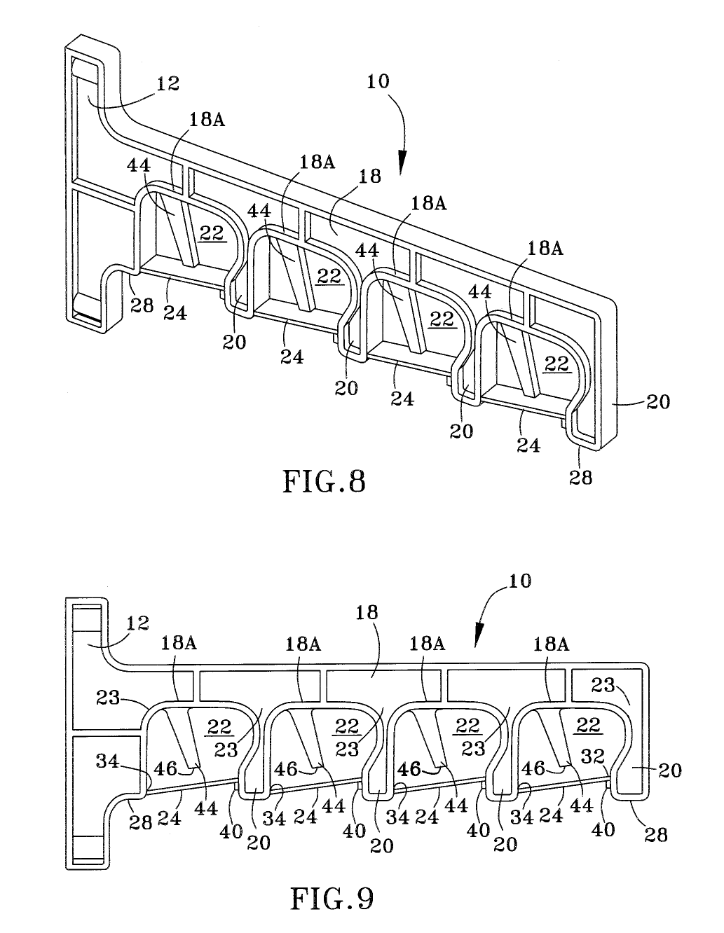

FIGS. 1 through 9 depict certain embodiments of a device 10 adapted for securing, suspending and organizing items in accordance with the present invention, with FIGS. 8 and 9 showing what is believed to be a preferred embodiment. The devices 10 can be fabricated from a variety of materials, with plastic believed to be preferred for purposes of cost and manufacturability. For convenience, identical reference numerals are used in the drawings to denote the same or equivalent elements throughout the various views.

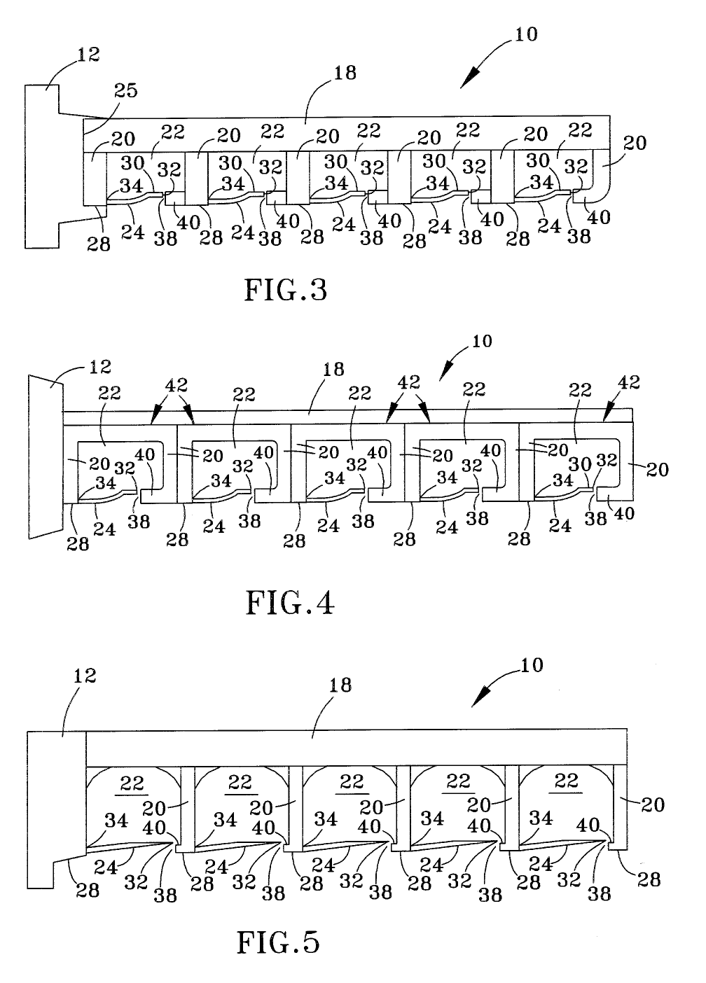

As represented in FIGS. 1 and 2, the device 10 is shown as having a base 12 that can be attached to a wall 14 or other vertical surface, for example, with screws inserted through holes 16 in the base 12. Extending from the base 12 is a rail 18 that may be attached to or formed integrally with the base 12. As will become evident from the following description, the device 10 is intended to be used with the rail 18 oriented in a generally horizontal position, though other orientations are possible. To facilitate the description of the device 10, the terms “vertical,” “horizontal,” “upward,” “downward,” “upper,” “lower,” “above,” “below,” etc., will be used in reference to the orientation of the device 10 as represented in FIG. 1, and therefore are relative terms and should not be interpreted as otherwise limiting the scope of the invention.

Multiple walls 20, which may be integral or attached to the rail 18, are shown in FIGS. 1 and 2 as extending downward from the rail 18 to define separate spaces or slots 22 between the base 12 and a first of the walls 20 and thereafter between each adjacent pair of walls 20. The walls 20 are shown as extending perpendicular to a longitudinal side 18A of the rail 18, though a perpendicular orientation is not required and therefore various transverse orientations are also within the scope of the invention. To promote the rigidity of the walls 20, reinforcements or supports 23 are integrally formed, attached or otherwise provided at the intersections of the walls 20 with the rail 18 to minimize flexing of the walls 20. The walls 20 are represented as being of approximately equal lengths, though walls 20 of different lengths are also within the scope of the invention. The slots 22 have a roughly rectilinear shape as a result of the walls 20 being oriented perpendicular to the rail 18, though this shape is not necessary for the operation of the device 10.

A resilient tab 24 is shown as being disposed at the lower end of each slot 22. The tabs 24 are depicted as generally straight (linear) and extending roughly horizontally in a direction away from the base 12 and roughly parallel to the longitudinal direction of the rail 18. The tabs 24 are shown in FIGS. 1 and 2 as defining joints 34 with the base 12 and a distal end 28 of each wall 20 except for the wall 20 farthest from the base 12, though it is foreseeable that the tabs 24 could extend toward the base 12 and define joints with all of the walls 20. The joints 34 of the tabs 24, which may be the result of a separate attachment operation or the result of integrally forming the tabs 24 with the base 12 and walls 20, are formed to provide a biasing effect that causes the tabs 24 to be biased away from the rail 18. The tab 24 of the leftmost slot 22 nearest the base 12 in FIG. 1 is in a free state position outside its slot 22, whereas the tabs 24 of the second through fifth slots 22 from the base 12 have been deflected into positions within their respective slots 22, and as a result are subject to the biasing forces applied by their respective joints 34 that urge the tabs 24 away from the rail 18.

In FIGS. 1 and 2, each tab 24 is longer than the width of the slot 22 that it spans (for example, by about one to two millimeters), creating a toggling effect between the free-state position outside of the slot 22 as shown for the leftmost slot 22 in FIG. 1 and the deflected position within the slot 22 as shown for the second through fifth slots 22 from the base 12 in FIG. 1. In its free state (as shown in the leftmost slot 22 of FIG. 1), each tab 24 is inclined downward. For example, the tabs 24 may be inclined about four degrees from a plane containing the distal ends 28 of the walls 20. Each tab 24 is further shown as having a distal portion 30 that is further inclined from the remainder of the tab 24, for example, about four degrees from a plane defined by the remainder of the tab 24 (forming an obtuse angle with the remainder of the tab 24), and therefore about eight degrees from the plane intersecting the distal ends 28 of the walls 20. The orientation of the distal portion 30 of each tab 24 facilitates toggling of the tab 24 upward into its respective slot 22, as evident from comparing the first and second slots 22 from the base 12 in FIG. 1. Releasing the tab 24 of the second slot 22 causes the biasing of the tab 24 to engage its distal end 32 with the adjacent wall 20, as shown for the third and fourth slots 22 from the base 12 in FIG. 1. The fifth slot 22 from the base 12 shows a bagged product 26 secured and sealed by a pinch point resulting from the distal end 32 of the tab 24 being urged downward toward the side of its adjacent wall 20 and into engagement with an edge of the product 26.

As a result of the above construction, the product 26 is able to be secured with the device 10 by placing the edge of the product 26 in a gap 36 that is present between the distal end 32 of the tab 24 and the adjacent wall 20 when the tab 24 is in its free state (leftmost slot 22 in FIG. 1), then pushing the tab 24 upward into the slot 22 against the biasing force of its joint 34 (second slot 22 from the base 12 in FIG. 1), then pushing the tab 24 to resiliently deflect upward into its slot 22 so that the edge of the product 26 is within the slot 22. By releasing the product 26, the joint 34 forces the tab 24 downward, causing the distal end 32 of the tab 24 to be biased toward the adjacent wall 22 (third and fourth slots 22 in FIG. 1) and into engagement with the edge of the product 26 (fifth slot 22 of FIG. 1). The pinch point is preferably capable of closing and sealing an open edge of the product 26 and suspending the product 26 from the device 10. The product 26 can easily be removed from the slot 22 by lifting the tab 24, such as shown for the second slot 22 in FIG. 1. Alternatively, the product 26 can be released by pulling downward to force the tab 24 to toggle and reacquire its downward free-state orientation.

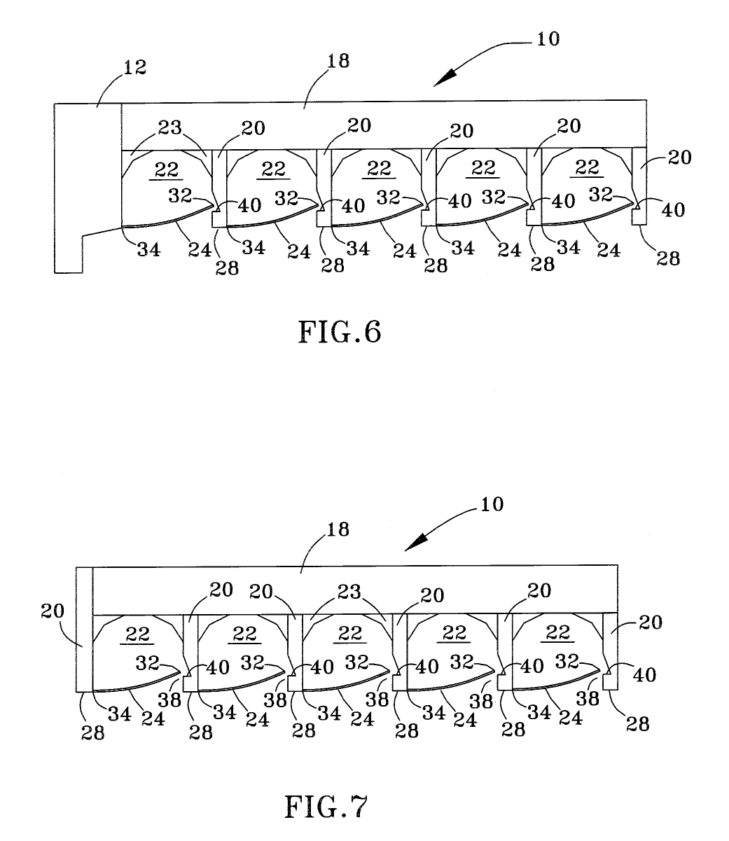

In view of similarities between the first embodiment of FIGS. 1 and 2 and the remaining embodiments of the invention, the following discussion of FIGS. 3 through 9 will focus primarily on aspects of the additional embodiments that significantly differ from the first embodiment. Other aspects of the additional embodiments not discussed in any detail can be, in terms of structure, function, materials, etc., essentially as was described for the first embodiment.

The embodiment of the device 10 shown in FIG. 3 differs in part by forming the base 12 separately from the rail 18 and its walls 20, and then assembling the rail 18 to the base 12 with fasteners (not shown) or any other suitable means. With this embodiment, the first tab 24 is attached to a wall 20 instead of the base 12, and this wall 20 and the end of the rail 18 are received and secured within a channel 25 in the base 12. Alternatively, the rail 18 can be used without the base 12 and mounted directly to a horizontal or vertical surface, such as beneath a cabinet or shelf.

In addition, the device 10 shown in FIG. 3 differs as a result of the tabs 24 (other than their distal portions 30) having arcuate shapes whose concave sides face their respective slots 22. Also contrary to the embodiment of FIGS. 1 and 2, the tabs 24 are not longer than the widths of the slots 22, and their distal ends 32 directly face the adjacent walls 20 when the tabs 24 are in their free state (as shown). As a result, the toggle-action of the tabs 24 described for FIGS. 1 and 2 is eliminated, the distal ends 32 of the tabs 24 do not directly engage their adjacent walls 20, and the pinch point intended to secure an item is the result of an interference fit between the thickness of the item and a gap 38 between each distal end 32 and its facing wall 20. The pinch-point effect is enhanced by the presence of a shoulder 40 on each wall 20 facing the adjacent distal end 32 across the gap 38. The shorter tabs 24 shown for the device 10 of FIG. 3 can be more rigid than the tabs 24 of FIGS. 1 and 2, so as to be capable of providing an ample pinching or gripping action through the thickness of the item being gripped, even though the tabs 24 do not directly contact their facing walls 20.

The embodiment of the device 10 shown in FIG. 4 is similar to that of FIG. 3, but has a modular construction in which individual slots 22 are defined by a C-shaped unit 42. The units 42 are attached to the rail 18 (such as with fasteners), and adjacent units 42 cooperate to define the walls 20 between slots 22. Each unit 42 is also depicted as defining a shoulder 40 similar to that of FIG. 3.

The device 10 of FIG. 5 differs from previous embodiments as a result of the distal end 32 of each tab 24 having a more defined point capable of better pinching or gripping certain types of items, such as bags and packages.

The device 10 of FIG. 6 utilizes tabs 24 with a toggle-action similar to FIGS. 1 and 2, but differ as a result of having an arcuate shape along their entire lengths and engaging shoulders 40 defined by a notch in each facing wall 20 instead of shaping the walls 20 to have an L- or J-shaped cross-section. The toggle action of the tabs 24 is a result of the tabs 24 in FIG. 6 being longer than the widths of their respective slots 22. However, the combined effect of their lengths and arcuate shapes inhibit the tabs 24 from being deflected outside the slots 22. In FIG. 7, the tabs 24 are shorter than the widths of the slots 22 to provide a gripping action similar to that of FIGS. 3, 4 and 5. FIG. 7 also illustrates an example of the base 12 being omitted, such that the rail 18 is mounted directly to a surface, preferably a horizontal surface such as beneath a cabinet or shelf.

Finally, FIGS. 8 and 9 represent a device 10 configured as a one-piece structure, for example, as a result of fabrication by injection molding a suitable plastic material. As before, the device 10 can be seen to have a base 12 that can be attached to a wall or other vertical surface, a rail 18 extending from the base 12, walls 20 extending downward from the rail 18 to define slots 22 therebetween. Large radii (supports) 23 are present at the intersections of the rail 18 and walls 20 to minimize flexing of the walls 20, and the tabs 24 are longer than the widths of the slots 22 they span so as to engage shoulders 40 formed on their respective facing walls 20 and provide a toggle-action similar to FIGS. 1, 2 and 6. When engaged with its wall 20, each tab 24 is preferably inclined inward about eight degrees into its slot 22.

The device 10 of FIGS. 8 and 9 is further equipped with stop members 44 that project into the slots 22 from the rail 18. The stop members 44 function to limit the extent to which the tabs 24 are able to be resiliently deflected into the slots 22. The stop members 44 are represented in FIGS. 8 and 9 as extending from the longitudinal side 18A of the rail 18 in a direction transverse to the longitudinal direction of the rail 18, and to have a distal end 46 disposed adjacent the midpoints of the tabs 24 between adjacent walls 20.

Certain dimensions are believed to be exemplary and potentially preferred in order to promote the ability of the device 10 of FIGS. 8 and 9 to secure and suspend a wide variety of items. As an example, for the purpose of securing and suspending items such as bagged food products, jackets, hats, towels, swimming pool accessories like swim goggles, life jackets and floaties, and household and gardening items such as extension cords and bagged lawn and garden supplies, suitable dimensions are believed to include a length of up to about five centimeters (for example, slightly greater than 3.8 centimeters) for the tabs 24, a thickness of about one millimeter for the tabs 24, widths of up to about five centimeters (for example, about 3.8 centimeters) for the slots 22, and depths of up to about five centimeters for the slots 22.

While the invention has been described in terms of specific embodiments, it is apparent that other forms could be adopted by one skilled in the art. For example, the devices 10 could differ in appearance and construction from the embodiments shown in the Figures, and an embodiment of the invention may incorporate any of the features and functions described for any of the embodiments shown in the Figures. Furthermore, the functions of the tabs 24 and their joints 34 could be performed by components of different construction but capable of a similar (though not necessarily equivalent) function, and a wide variety of materials and processes could be used to fabricate the devices. Accordingly, it should be understood that the invention is not limited to the specific embodiments illustrated in the Figures. Instead, the scope of the invention is to be limited only by the following claims.

1. A device adapted for securing and suspending an item, the device comprising:
a rail extending in a longitudinal direction and having a longitudinal side;
at least first and second walls extending from the longitudinal side of the rail in directions transverse to the longitudinal direction, each of the first and second walls terminating at a distal end spaced apart from the rail, the rail and the first and second walls delineating a slot between the first and second walls;
a resilient member extending from the first wall and toward the second wall, the resilient member being operable to extend into the slot and be resiliently deflected between first and second positions within the slot; and
means for biasing the resilient member away from the rail so that in the first position of the resilient member a distal tip thereof is resiliently deflected toward the rail and defines a gap with the second wall for receiving a portion of an item, and in the second position of the resilient member the distal tip thereof is resiliently biased toward the second wall to define a pinch point therebetween for securing the item.

2. The device according to claim 1, wherein the biasing means comprises a joint between the resilient member and the first wall, the joint being defined by attaching the resilient member to the first wall or integrally forming the resilient member with the first wall.

3. The device according to claim 1, wherein the resilient member extends toward the distal end of the second wall and engages the distal end of the second wall when the resilient member is in the second position.

4. The device according to claim 1, wherein the biasing means resiliently biases the distal tip of the resilient member into contact with the second wall to define the pinch point.

5. The device according to claim 1, further comprising a shoulder defined on the second wall adjacent the distal end thereof, wherein the biasing means resiliently biases the distal tip of the resilient member into contact with and against the shoulder to define the pinch point therebetween.

6. The device according to claim 5, wherein the shoulder prevents the resilient member from being deflected to a position outside the slot.

7. The device according to claim 1, further comprising a stop member projecting into the slot and limiting the extent to which the resilient member is able to be resiliently deflected into the slot to the first position thereof.

8. The device according to claim 7, wherein the stop member extends from the longitudinal side of the rail in a direction transverse to the longitudinal direction of the rail.

9. The device according to claim 7, wherein the stop member has a distal end disposed adjacent a midpoint of the resilient member between the first and second walls.

10. The device according to claim 1, wherein the resilient member is adapted to be toggled between the second position within the slot and a third position outside the slot.

11. The device according to claim 1, wherein the resilient member has a distal portion nearest the second wall and a remaining portion of the resilient member is between the distal portion and the first wall, and the distal portion defines an obtuse angle with at least an adjoining portion of the remaining portion.

12. The device according to claim 11, wherein each of the distal and remaining portions of the resilient member is straight.

13. The device according to claim 11, wherein the remaining portion of the resilient member has an arcuate shape that defines a concave side facing the slot.

14. The device according to claim 1, further comprising a base from which the rail extends, the base being adapted for securing the rail to a structure chosen from the group consisting of walls, doors, cabinets and shelves.

15. The device according to claim 14, wherein the base is adapted for mounting to a surface transverse to the longitudinal direction of the rail.

16. The device according to claim 1, wherein the device further comprises:
at least a third wall extending from the longitudinal side of the rail in a direction transverse to the longitudinal direction, the third wall terminating at a distal end spaced apart from the rail, the rail and the second and third walls delineating a second slot between the second and third walls;
a second resilient member extending from the second wall and toward the third wall, the second resilient member being operable to extend into the second slot and be resiliently deflected between first and second positions within the second slot; and
means for biasing the second resilient member away from the rail so that in the first position of the second resilient member a distal tip thereof is resiliently deflected toward the rail and defines a gap with the third wall for receiving a portion of the item, and in the second position of the second resilient member the distal tip thereof is resiliently biased toward the third wall to define a pinch point therebetween for securing a second item.

17. The device according to claim 1, wherein the resilient member has a length of up to about five centimeters, the slot has a width of up to about five centimeters in a direction parallel to the longitudinal direction of the rail, and the slot has a depth of up to about five centimeters in a direction perpendicular to the longitudinal direction of the rail.

18. A method for securing and suspending an item, the method comprising:
pushing an edge of the item against a resilient member to cause the resilient member to resiliently deflect into a slot between first and second walls and enable the edge of the item to enter the slot through a gap between a distal tip of the resilient member and the second wall; and then
releasing the item, the resilient member being biased in a direction away from the slot so that the distal tip of the resilient member is resiliently biased toward the second wall to define a pinch point therebetween that secures the item.

19. The method according to claim 18, wherein prior to the pushing step the resilient member extends into the slot and during the pushing step the resilient member is resiliently deflected between first and second positions within the slot.

20. The method according to claim 18, wherein the first and second walls extend from a longitudinal side of a rail in directions transverse to a longitudinal direction of the rail, and the method further comprises mounting the rail so that the first and second walls extend downward and the pushing step comprises pushing the item upward into the slot.
